(19) United States
(12) Patent Application Publication
(10) Pub. No.: US 2003/0030679 A1
(43) Pub. Date: Feb. 13, 2003

(54) USER-DEFINABLE IMAGES IN BOOKMARKS

(76) Inventor: ANUJ KUMAR JAIN, RALEIGH, NC (US)

Correspondence Address: MOORE & VAN ALLEN, PLLC, 2200 W MAIN STREET, SUITE 800, DURHAM, NC, 27705, US

(21) Appl. No.: 09/478,585

(22) Filed: Jan. 6, 2000

(51) Int. Cl. G09G 5/00

(52) U.S. Cl. 345/854

(57) ABSTRACT

A method and system for bookmarking a favorite page with a user-defined image. The method comprises the steps of displaying a website page along with its locator address, displaying a plurality of images on the page, allowing a user to select one of the images, and storing the image together with the locator address to bookmark the website page. The system includes means for displaying a website page along with its locator address, means for displaying a plurality of images on the website page, means for allowing a user to select one of the images, and means for storing the selected image together with the associated locator address as a bookmark for the website page.

### BACKGROUND OF THE INVENTION

Users on the Internet utilize browser software to navigate from within one page to another page. Hypertext Markup Language (HTML) was developed to allow users to navigate more easily through these pages. Each page is located at an address represented by a Universal Resource Locator (URL), and may reside on a user's own computer, or on another networked computer called a host. A logical grouping of HTML pages on a given host is known as a website. An HTML page displayed by a browser generally contains hypertext links that, when selected by a user, cause the browser to load and display other HTML pages. Each link is associated with a URL of a destination HTML page that may be located at a website residing at a different location.

To revisit a favorite page, the user may re-enter the entire URL address of the website, which may contain many characters, into the browser program every time he or she desires to revisit the page. FIG. 1 shows a list 101 of URL addresses, which the user has visited previously. This list can be obtained by selecting the “location” field 102 of the browser program or navigator 100. One problem with this way of re-visiting a page is that storing only URL addresses is not an effective way of associating the address to the content of its page.

Alternatively, to revisit a favorite page, a user may represent its URL address with a textual description of the page, so that the user can easily remember and distinguish his or her favorite page without a need to remember its exact URL address. This process in known as bookmarking.

FIG. 2 shows a list of bookmarks 200 as implemented in the “Netscape Navigator”™ browser, wherein a browser-installed generic icon 201 is placed in front of a textual bookmark 202, for example. One problem with the bookmark implementations of FIG. 2 is that the browser dictates the generic bookmark images in bookmark list 200, and thus a user of this program is not allowed to change these images. Furthermore, these generic bookmark images do not help the user effectively associate his or her favorite URL page with an easy-to-recognize image of his or her choice.

Although a user may change a browser-installed generic bookmark image in the “Internet Explorer” (IE) version 4 or 5, these IE browsers require that the bookmarked site store a file named “favicon.ico” at either the root or at the document base directory. Otherwise, if the site does not have a “favicon.ico” file the IE browser version 4 or 5 puts a generic image in the bookmark. To illustrate how IE browser version 4 or 5 allows a user to modify a generic bookmark image, reference is made to FIGS. 3-6 as follows.

FIG. 3 shows a website page 300 in IE version 4 or 5. Here, assuming that website 300 does not have a “favicon.ico” at either the root or at the document base directory, the browser has installed a generic icon 301 in front of the URL address 302. The IE browser version 4 or 5 allows a user to change the generic image 301 to another predetermined image. Assuming that the site 300 has been already bookmarked, the user may initiate the process of changing the generic image 301 by first selecting “Favorites” 303 in FIG. 3, next selecting “Organize Favorites” (not shown), and then selecting “Properties” 400 in FIG. 4. Consequently, the IE browser presents the user with FIG. 5, which shows the URL address 500 and the “change icon” button 502. After clicking on button 502, the exemplary images 501 from a user-specified default storage directory are presented to the user. Now the user may select one of the images 501, for example image 503, and hit the “OK” button to change the bookmark icon 301. If there are no images stored in the user-specified directory or the user wishes to use different images, he or she may switch to a different directory. FIG. 6 shows the page 300 in FIG. 3 that is bookmarked with the new user-selected bookmark icon 601 in front of the bookmark text 602.

The above implementation of bookmarking, as implemented in IE version 4 or 5, has several problems. First, the appearance and the variety of the images 501 are beyond the user's control. That is, the user is limited to selecting a bookmark icon among only the available images 501. Secondly, the above implementation of bookmarking in IE version 4 or 5 creates unnecessary Hypertext Transfer Protocol (HTTP) traffic, especially when bandwidth is low. This is because every time a user requests for a bookmark in an IE browser, the browser sends an HTTP-formatted request for a “favicon.ico” file in the same URL base site where it found the page to be bookmarked. If the IE browser could not find the “favicon.ico” file there, the browser makes another try to find the “favicon.ico” file in the root directory of the website. At this point if a “favicon.ico” file cannot be found, the IE browser finally stops searching and the browser places a default generic image in front of the bookmark text.

There is a need, therefore, for providing user-definable images for bookmarking favorite pages in a flexible way that overcome the problems of the prior art.

### SUMMARY

The system and method of the presently preferred embodiments of the present invention allow a user to bookmark a favorite website with an image of her or his choice in a flexible way.

In accordance with the present invention, a method and system for bookmarking a favorite page with a user-defined image is provided. In one aspect of the invention, the method comprises the steps of displaying a website page along with its locator address, displaying a plurality of images on the page, allowing a user to select one of the images, and storing the image together with the locator address to bookmark the website page.

The invention may also be embodied in a system including means for displaying a website page along with its locator address, means for displaying a plurality of images on the website page, means for allowing a user to select one of the images, and means for storing the selected image together with the associated locator address as a bookmark for the website page.

The method and system of the present invention present the user with the option of turning on the image bookmarking capability, or otherwise staying with traditional text-only bookmarking. A user may activate the image bookmarking option by selecting the “Bookmarking with Images or Icons” (“BWI”) item under the browser's “preferences” to activate a software module in the browser. Once a user turns on the module, it determines if any image is present in the site to be bookmarked. If the site to be bookmarked has at least one image, the module presents that image to the user, which the user can select wholly or partially for bookmarking using automatically presented image-editing tools. The module also resizes the selected part of the image to the appropriate size for bookmarking and then updates the bookmark tree in the browser program. If, however, no image can be found in the page to be bookmarked, the program determines whether the user has pre-specified other URL sites. If the user has specified another URL site of his or her choice, by selecting one from a user-requested dialog-box, the module retrieves and presents to the user with a set of images from the user-specified site. Finally, if the user-specified site has no image or the user has not specified any URL site, the software module presents the user with a default image for bookmarking.

The foregoing discussion of the preferred embodiments has been provided only by way of introduction. Nothing in this section should be taken as a limitation on the following claims, which define the scope of the invention.

### BRIEF DESCRIPTION OF SEVERAL VIEWS OF THE DRAWINGS

FIG. 1 shows a list of previously visited URL addresses displayed in accordance with the prior art;

FIGS. 2-3 show exemplary screen display lists of generic bookmarks displayed in accordance with the prior art;

FIGS. 4-6 show exemplary screen displays of steps in involved changing generic bookmarks in accordance with the prior art;

FIGS. 7-8 show exemplary generic bookmarks according to the prior art;

FIGS. 9-10 show exemplary views of steps involved in selecting and changing bookmarks according to the presently preferred embodiments of the present invention; and

FIG. 11 is a flow diagram according to the presently preferred embodiments of the present invention.

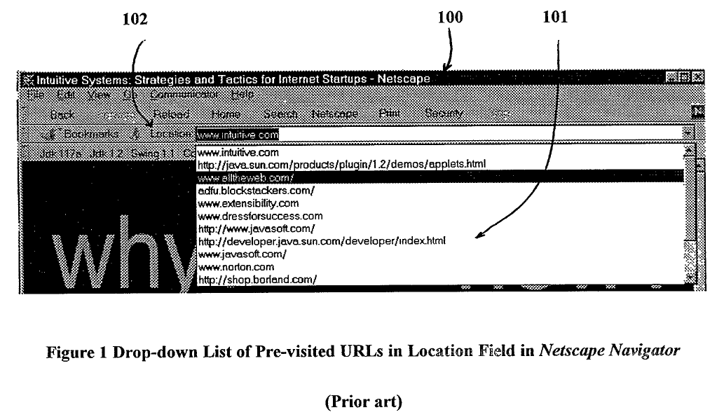

### DETAILED DESCRIPTION OF THE PRESENTLY PREFERRED EMBODIMENTS

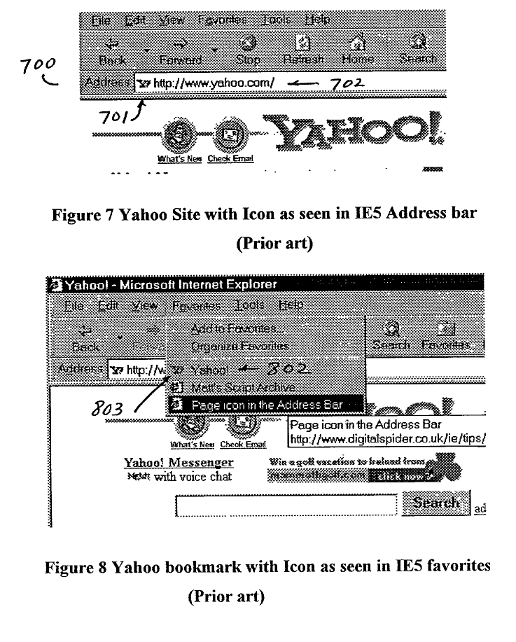

One aspect of the present invention for changing a bookmark icon for a website that includes a “favicon.ico” file is described in conjunction with the FIGS. 7-11. Turning now to FIG. 7, a “Yahoo” site 700 is shown in Internet Explorer IE browser version 5 (IE5). The browser detects the generic icon 701 in the “favicon.ico” file and places it in front of the URL address 702. FIG. 8 shows the bookmarked version of the site in FIG. 7, as obtained by selecting “Favorites” 801, wherein the bookmark consists of the text “Yahoo” 802 and the icon “Y” 803. The “favicon.ico” file contains a predetermined image, such as 803, which is automatically inserted in front of bookmark text 802 in FIG. 8.

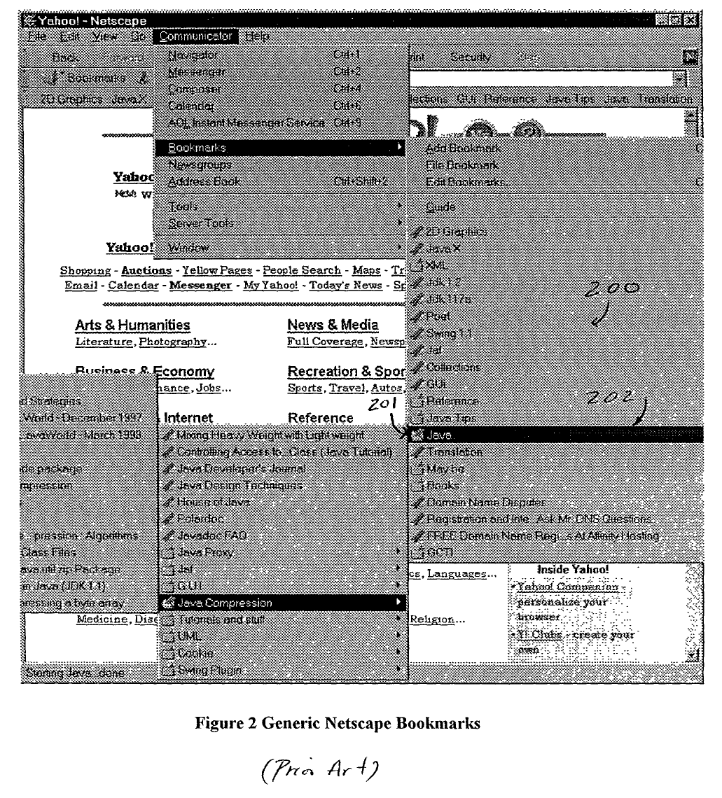

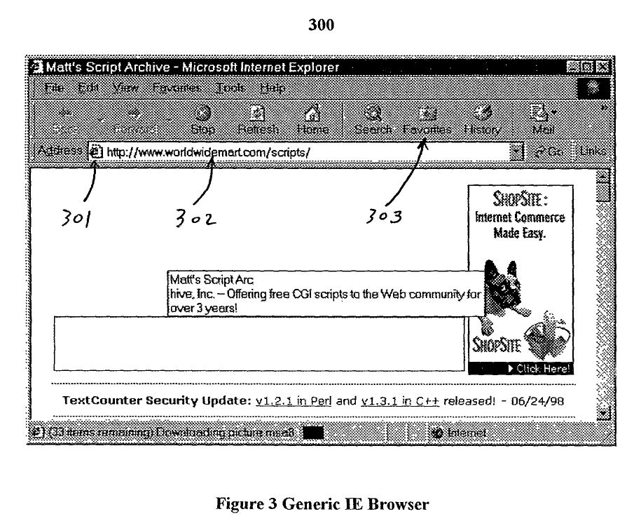

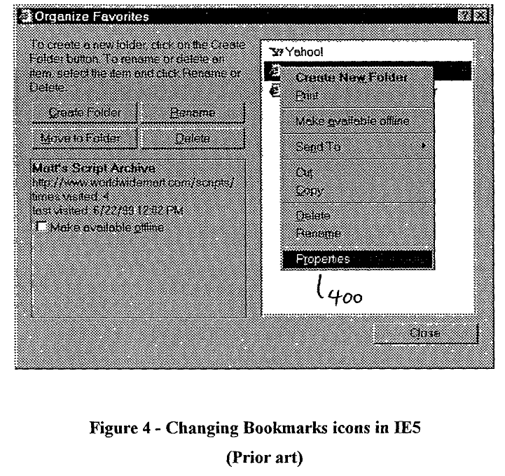

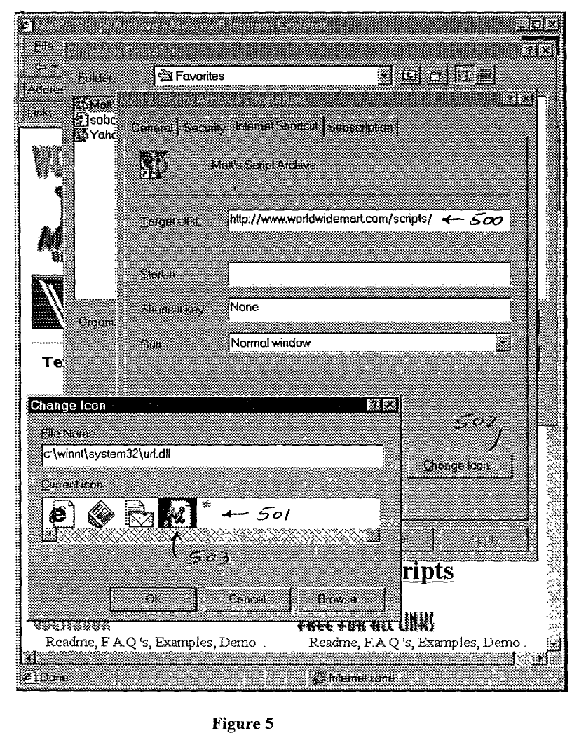

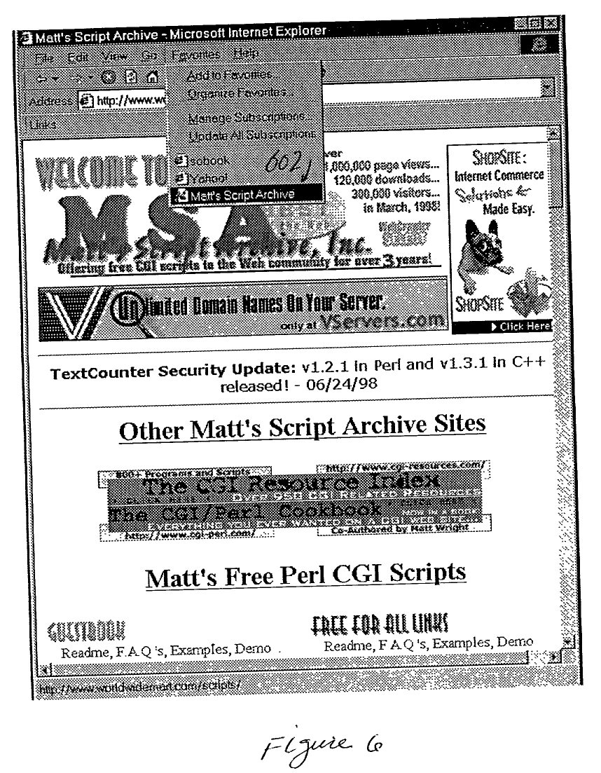

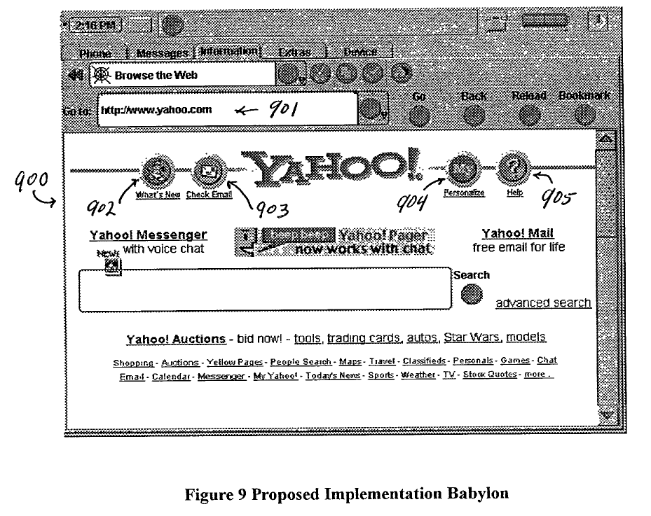

To describe how to change the bookmark icon 803 according to an aspect of the present invention, reference is made to FIGS. 9-11. Of course, the following exemplary description applies to any available browser program, and it should not be limited to a particular browser environment. Furthermore, the presently preferred embodiments may be implemented on a computer system or network of computer systems, wherein each computer includes a processing unit, a display unit, and input devices (mouse, pen, touch and voice sensitive tools, etc.) which are well within contemplation of persons of ordinary skill in the art. FIG. 9 shows a website page 900 downloaded using any available browser. The site 900 is associated with the URL address 901, which is intended to be the subject reference for a bookmark. The user has the option of bookmarking this site with a traditional text-only bookmark, as in FIG. 2, or with an image of choice by preferably turning on a module called “Bookmarking with Images or Icons” (“BWI”) in the browser's “Preferences.”

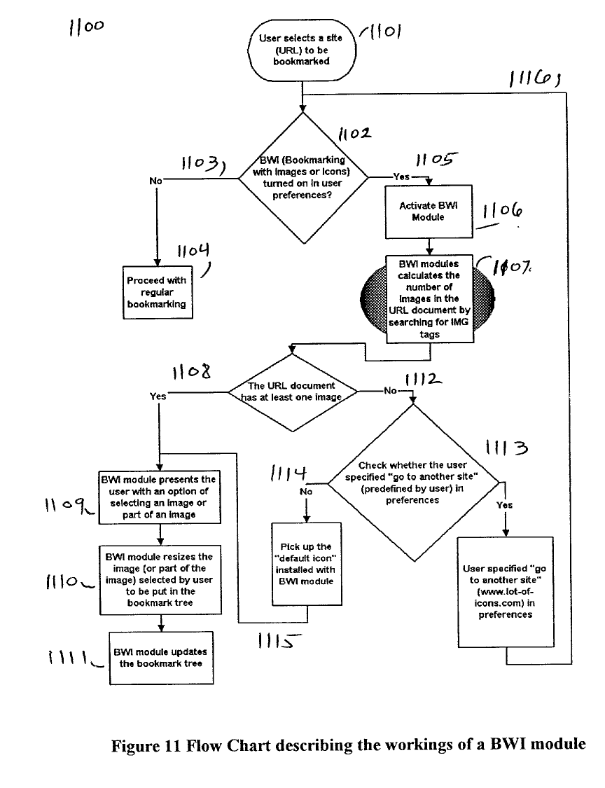

Referring to FIG. 11, a flowchart 1100 is shown describing the presently preferred embodiments. If the user has not turned on the BWI module 1103, the browser proceeds with text-only bookmarking 1104. However, if the user has turned on the BWI module 1105, the BWI module is activated 1106 and it calculates 1107 the number of images in the URL site to be bookmarked by searching for image tags “IMG<tags>” 1107. If the BWI module finds at least one image in the site to be bookmarked 1108, the module preferably presents the images to the user 1109. The user has the option of selecting a whole image or a part of an image 1109. After a user selects an image, the BWI module resizes the selected image 1110 to the appropriate size image that can be positioned in front of the URL address. The BWI module then updates the bookmark tree 1111.

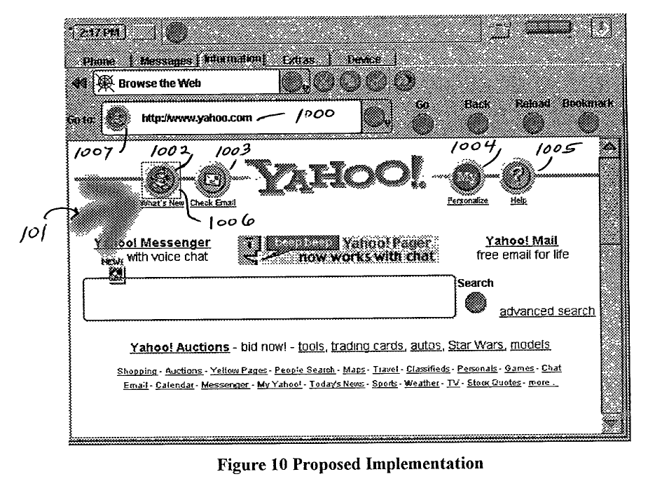

FIG. 9 shows four exemplary images 902-905. A user can select any one of these images by placing the cursor 1001 on one of the images 1002-1005, such as image 1002 in FIG. 10. The cursor 1001 is displayed in a highlighted form by the BWI module as soon as this module is activated in 1106 of FIG. 11. The user may select the whole image, such as 1002 in FIG. 10, or a portion of it, by enclosing the desired part of the image within an automatically generated box tool 1006 which is displayed by the BWI module upon its activation in 1106. Next, in step 1110 of FIG. 11, the BWI module preferably resizes the user-selected image to the appropriate size to be put in front of the URL address 1000. Finally, in step 1111 of FIG. 11, the BWI module preferably updates the bookmark tree and the URL address 1000 by placing the image 1007 next to it, as shown in FIG. 10.

A user may not desire the particular images 1002-1005 in FIG. 10, which are derived from the website page to be book marked and presented to the user by the BWI module. The website page to be bookmarked also may not contain any image 1112. In this case, the BWI module preferably determines at 1113 whether the user has specified another website that may contain downloadable icon images for use in bookmarking in accordance with an aspect of the present invention. The user may also specify another site that contains images by selecting one of a plurality of predetermined sites that are presented to the user in a dialog box upon his or her request. The user may predefine such URL sites in the browser's configuration menu. One such user-specified site may be labeled “go to another site” that is addressed by URL “www.lots-of-icons.com.” Each one of the predefined sites should have at least one image. If the user has specified another website 1116, the BWI module then loads the user-specified site and goes through the same steps starting at 1102 to determine if the user-specified site has any image. Assuming that the user-specified site has at least one image 1108, the images are then loaded to the website page and are presented to the user for selection in step 1109 of FIG. 11.

If, however, the website to be bookmarked has no image 1112, and the user has not specified any other website for the BWI module to search, the BWI module picks up a default icon 1115 and presents it to the user in step 1109.

The presently preferred embodiments of the present invention have several advantages over the prior art systems and methods of bookmarking. First, the iconic bookmarking as disclosed herein is browser independent. Second, the user is free to choose among the bookmark images of his or her choice. The images are taken from the website page to be bookmarked or from another site that the user selectively specifies. The prior art systems dictate the images that the user may choose from. Thirdly, no unnecessary HTTP traffic is generated by the present system because after the user selects a bookmark image, the BWI module retrieves the selected image from internal cache memory. This feature becomes significant in narrow bandwidth devices, such as Personal Data Assistant (PDA) systems. Finally, the preferred design and implementation of the image bookmarking method and system as presented herein does not require the involvement of the website providers.

While a particular embodiment of the present invention has been shown and described, modifications may be made. Furthermore, the inventive concept described herein may be applied to environments other than Internet systems, such as electronic books and the like. It is therefore intended for the appended claims to cover all such changes and modifications, which fall within the true spirit and scope of the invention.

What is claimed is:

1. A method for bookmarking a website page comprising:
(a) displaying a website page along with its locator address;
(b) displaying a plurality of images on said website page;
(c) selecting one of said images; and
(d) bookmarking said website page with said selected image.

2. The method of claim 1 wherein said act in (b) further comprises displaying said images derived from said website page.

3. The method of claim 1 wherein said act in (b) further comprises displaying said images derived from a website page specified by the user.

4. The method of claim 2 wherein said act in (b) further comprises displaying default image if said website page does not contain an image.

5. The method of claim 1 wherein said act in (c) further comprises requesting that a user select a part or all of one of said images.

6. The method of claim 1 wherein said act in (d) further comprises resizing said selected image.

7. A system for bookmarking a website page, comprising:
(a) means for displaying a website page;
(b) means for displaying a plurality of images on said website page;
(c) means for selecting one of said images; and
(d) means for bookmarking said website page with said selected image.

8. The system of claim 7 wherein said means for displaying further comprises means for displaying said images derived from said website page.

9. The system of claim 7 wherein said means for displaying further comprises means for displaying said images derived from a website page specified by a user of the system.

10. The system of claim 8 wherein said means for displaying further comprises means for displaying a default image if said website page has no image and no other website is specified by a user of the system.

11. The system of claim 7 further comprising means for selecting a part of said one of said images.

12. The system of claim 7 wherein said means for bookmarking includes means for resizing said image.

13. A system for bookmarking a website page, comprising:
(a) a device that provides a website page;
(b) a device that provides a plurality of images;
(c) a device that selects one of said images; and
(d) a device that bookmarks said website page with said selected image.

14. The system of claim 13 wherein said device in (b) provides said images derived from said website page.

15. The system of claim 13 wherein said device in (b) provides said images derived from a website page specified by a user of the system.

16. The system of claim 14 wherein said device in (b) further provides a default image if said website page has no image and no other website is specified by a user of the system.

17. The system of claim 13 wherein said device in (c) further requests that a user of the system select a part or all of said one of said images.

18. The system of claim 13 wherein said device in (d) further resizes said image before said bookmarking.

19. A method for bookmarking a website page comprising:
(a) providing a website page;
(b) allowing a user to define an image for associating with said website page;
(c) bookmarking said website page with said image.

20. The method of claim 19 wherein said act in (b) further comprises requesting that the user define said image derived from said website page.

21. The method of claim 19 wherein said act in (b) further comprises requesting that the user define said image derived from a website page specified by the user.

22. The method of claim 20 wherein said act in (b) further comprises defining said image derived from a default image if said website page does not contain an image.

23. The method of claim 19 wherein said act in (c) further comprises resizing said defined image.
